(19) United States
(12) Patent Application Publication
(10) Pub. No.: US 2015/0167500 A1
(43) Pub. Date: Jun. 18, 2015

(54) METALLURGICAL PLANT

(71) Applicant: SIEMENS AKTIENGESELLSCHAFT, München (DE)

(72) Inventors: Ralph-Herbert Backes, Erlangen (DE); Arno Döbbeler, Herzogenaurach (DE); Andreas Heinemann, Hirschaid (DE); Thomas Matschullat, Eckental (DE)

(73) Assignee: SIEMENS AKTIENGESELLSCHAFT, München (DE)

(21) Appl. No.: 14/398,022

(22) PCT Filed: Apr. 29, 2013
(86) PCT No.: PCT/EP2013/058854

§ 371 Date: Oct. 30, 2014

(30) Foreign Application Priority Data
May 3, 2012 (EP) 12166573.1

(51) Int. Cl. F01K 23/06; G05F 1/66; F01K 23/18; G05B 15/02; F02C 6/04; F01K 23/10

(52) U.S. Cl. CPC F01K 23/064; F02C 6/04; F01K 23/10; F01K 23/18; G05B 15/02; G05F 1/66; F05D 2270/13; F05D 2220/72; F05D 2220/32

(57) ABSTRACT

Two or more metallurgical sub-plants, a separate network for the distribution of electrical energy, at least one power generating plant with at least one gas turbine for the provision of electrical energy in the separate network, and a control device are included in a metallurgical plant. The sub-plants draw at least 80%, in particular at least 90%, of the electrical power required for their operation from the at least one power generating plant via the separate network. The control device controls provision of electrical power for a first sub-plant at the expense of at least one other of the two or more sub-plants. The two or more sub-plants include at least one steel works with at least one electric arc furnace and at least one sub-plant for a metallurgical process arranged upstream or downstream of the steel works.

### CROSS REFERENCE TO RELATED APPLICATIONS

This application is the U.S. national stage of International Application No. PCT/EP2013/058854, filed Apr. 29, 2013 and claims the benefit thereof. The International Application claims the benefit of European Application No. 12166573 filed on May 3, 2012, both applications are incorporated by reference herein in their entirety.

### BACKGROUND

Described below are a metallurgical plant and a method for supplying a metallurgical plant with electrical energy.

KRUMM, W. et al., “Optimierung der Energieverteilung im integrierten Hüttenwerk”, Stahl and Eisen, Düsseldorf (DE), 1988, Vol. 108, No. 22, pp. 95-104, describes a model for optimizing energy distribution in an integrated iron and steel works having a coke-fired blast furnace and a steam power generating plant for supplying energy-consuming loads of the iron and steel works with electricity and steam.

Electric steel plants are characterized by high electrical load changes, these being caused by a cyclic activation and deactivation of large-scale electricity-consuming loads, the electric arc furnaces, called arc furnaces or EAFs for short. During the operation of an EAF there are times when power outputs of typically more than 100 MW are drawn from the electricity grid. In this context the timescales of such EAF load changes are considerably shorter than typical response times of power generating plant turbines. Due to the high and rapid load changes there exists the risk of unwanted harmonic distortion effects being fed back into the electricity grid and threatening the stability of the electricity supply and consequently the continuous operation of the steelworks.

In high-performance integrated networks, such as exist in industrialized countries, a plurality of power generating plants and consumer centers are interconnected to form a grid, thereby enabling local differences between supply and demand in terms of instantaneous power within the network, e.g. the shedding of loads or load surges resulting from the operation of EAFs in an electric steel plant, to be anticipated and compensated for.

In contrast thereto, such load-balancing possibilities have hitherto been missing in a separate network, i.e. in an autonomous network decoupled from a public electricity grid or other electricity networks, thus leading to frequent network disruptions and consequently to a high risk of failure of the electricity supply. However, the stability of the electricity network and with it the possibility of continuous production are essential for cost-effective operation of an electric steel plant. For these reasons supplying an electric steel plant exclusively in an isolated standalone mode of operation has been avoided in the known art or been made possible only by high levels of investment in complex and expensive static VAr compensation systems.

On the other hand it must not be overlooked in this context that a separate autonomous network offers considerable advantages when a relatively weak public network is unable to or cannot reliably deliver the electrical power required by a load and/or when a remote load would require long-distance power lines subject to unacceptable transmission losses.

### SUMMARY

Described below is a metallurgical plant which can be supplied with electrical energy by way of a separate autonomous network, as well as a corresponding method.

The metallurgical plant operates in isolation on a standalone basis and includes two or more metallurgical sub-plants, a separate autonomous network for distributing electrical energy, at least one power generating plant for providing electrical energy in the separate autonomous network, and a control device, wherein a connection of the separate autonomous network to an external electrical power supply network permits a transmission of less than 20%, in particular less than 10%, of the electrical power required for the operation of the sub-plants, the power generating plant has at least one gas turbine, a provision of electrical power for a first sub-plant at the expense of at least one other of the two or more sub-plants can be controlled by the control device, and the two or more sub-plants include at least one steelworks having at least one electric arc furnace and at least one sub-plant for a metallurgical process arranged upstream or downstream of the steelworks. In a method for supplying a metallurgical plant having two or more metallurgical sub-plants with electrical energy in isolated standalone operation by way of a separate autonomous network, electrical energy is provided in the separate autonomous network by a power generating plant by delivering at least 80%, in particular at least 90%, of the electrical power required for the operation of the sub-plants from the separate autonomous network with the power generating plant having at least one gas turbine; and controlling a provision of electrical power for a first sub-plant at the expense of at least one other of the two or more sub-plants, the two or more sub-plants including at least one steelworks having at least one electric arc furnace and at least one sub-plant for a metallurgical process arranged upstream or downstream of the steelworks.

A separate “autonomous network” is considered to be an electricity network that is largely decoupled from other, in particular public, electrical power supply networks and has electricity-consuming loads connected thereto, where what is understood by the term “largely” is that either a proportion of at least 80%, in particular of at least 90%, of the electrical power drawn by the loads of the separate autonomous network is covered by one or more power generating plants in the separate autonomous network, or that at least 80%, in particular at least 90%, of the short-circuit power available in the separate “autonomous network” at the busbar on a higher level with respect to the power generating plants and electricity-consuming loads is provided by the generators of the one or more power generating plants in the separate autonomous network. A secondary connection of the separate autonomous network to another, in particular public, electrical power supply network is inconsequential in this case provided the electrical power delivered into the separate autonomous network by way of the secondary connection accounts for a share of less than 20%, in particular less than 10%, of the total electrical power consumed in the separate autonomous network. Under these conditions the operation of the electricity-consuming loads of the separate autonomous network is referred to as “isolated standalone operation”. Such a secondary connection may have been provided originally, e.g. during the construction of the metallurgical plant, primarily for supplying individual, relatively unimportant electricity-consuming loads of the separate autonomous network, e.g. worker accommodations or an emergency power supply.

A separate “autonomous network”, according to the definition given above, behaves in practice like a “genuine” island network, i.e. an electricity network that is completely decoupled from other, in particular public, electrical power supply networks and has electricity-consuming loads connected thereto. This is based on the recognition that in a separate autonomous network the step change in load generated by an EAF, in particular in the case of an arc break, i.e. a sudden shedding of load by one or more generators, can lead to an instability in the network. While this represents a positive step change in load, i.e. an increase in load, a negative step change in load, i.e. an abrupt outage of the load, which leads to an increase in rotational speed at a generator shaft, is to be considered as even more critical because it is less amenable to influence. This case is all the more critical, the closer the arc furnace power approaches the power of the power generating plant in the vicinity of the furnace, and the fewer individual generator blocks the power generating plant has (in the most unfavorable case only one block/generator), and the less support is to be expected from the public network, i.e. “the more sudden load change” must be carried by a generator, which could become unstable as a result.

In this situation the type of generators, the control of the power generating plant, the network configuration, etc. also play an important role, so that the above definition of the term “separate autonomous network” is given in the sense of a simple “setting of boundaries” of 80% or 90%.

The method overcomes one technical preconception: Previously it was considered technically complicated and uneconomic in the metallurgy sector to supply an electric steel plant with electrical energy exclusively in an isolated standalone mode of operation. Cost-effective isolated standalone operation of an electric steel plant is achieved by a combination of different measures:

Integration, into the metallurgical plant, of two or more metallurgical sub-plants which can be operated independently of one another. Because more sub-plants than previously are in operation in the separate autonomous network (the greater the number of consumers of electricity in the separate autonomous network, the better), differences between supply and demand in terms of instantaneous power within the separate autonomous network are successfully anticipated and compensated for, in particular when non-time-critical base load plants are present which can be shut down in favor of EAFs.

Modern energy generation by one or more gas turbines. Gas turbines have relatively short startup times and possess a higher dynamic in respect of the changeover of the operating states than steam turbines, which affords the possibility of fast load changes. The intelligent control of electricity generation by one or more gas turbines (“generation control”) takes positive and negative load reserves into account in the choice of the turbines.

Intelligent control of the energy distribution by a control device which controls a provision of electrical power for a first sub-plant at the expense of at least one other of the two or more sub-plants. When there are a plurality of electricity-consuming loads having different priorities, in particular when non-time-critical base load plants are present which can be shut down in favor of EAFs, differences between supply and demand in terms of instantaneous power within the separate autonomous network are successfully anticipated and compensated for.

The two or more metallurgical sub-plants can be two or more EAFs, in particular N EAFs, where N is a natural number. It is, however, also possible for the two or more metallurgical sub-plants to include one or more EAFs and at least one plant which is positioned upstream or downstream of the one or more EAFs in the metallurgical process.

The two or more sub-plants include at least one steelworks having at least one electric arc furnace and at least one sub-plant for a metallurgical process arranged upstream or downstream of the steelworks.

According to a development, the at least one sub-plant for a metallurgical process arranged upstream or downstream of the steelworks is one or more of the following plants: ore extraction plant, ore processing plant, pellet plant, iron making plant, direct reduction plant, casting plant, shaping plant, finishing plant, conveyor plant, auxiliary plant. The sub-plants can be used for extracting, conveying and safeguarding or consolidation activities. Excavators, belt and chain conveyors, drilling rigs, coal ploughs, and charging trucks and transportation vehicles or other plants for ancillary works, auxiliary plants (“auxiliary units”) and ancillary systems, e.g. infrastructure ancillary systems such as worker accommodations, recreation areas or cloakrooms, can also be regarded as sub-plants.

According to a development, the first sub-plant is a steelworks having at least one electric arc furnace. It is advantageous that the at least one EAF is precisely one EAF or two EAFs or more than two EAFs.

According to a development, the at least one electric arc furnace is embodied in such a way that charging and/or tapping and/or electrode replacement can be carried out quickly and easily. Thus, for example, the EAF can have an eccentrically arranged bottom tap hole, thereby significantly simplifying the tapping process. It is also possible for the EAF to have water cooling of wall and/or roof and/or electrodes. Energy-saving metallurgical methods or systems lead to a reduction in energy demand and/or load dynamics, which is very advantageous for a separate autonomous network.

The at least one electric arc furnace may be an arc furnace having at least one electrode.

According to a development, the control device is connected by way of data lines for exchanging process data, in particular via redundantly configured bus lines and/or optical data lines, to at least one of the two or more sub-plants and to the at least one power generating plant. The cable lines may be implemented as a hardwired cabling arrangement in order to be able to ensure reliable, high-speed data transmission. The data exchange between the two or more sub-plants and the at least one power generating plant can be realized by a data loop line.

According to a development, the at least one power generating plant is a GS power generating plant (GS=gas and steam turbines). The at least one power generating plant may have at least one gas and steam turbine block. The dynamics of modern energy generation, in particular short startup times and the possibility of rapid load changes, can be utilized by a GS power generating plant or a suitable choice of turbine. It is accordingly possible to form a positive or negative load reserve.

According to a development, the plant has at least one storage unit for buffering electrical energy, a temporary storage of electrical energy in the storage unit being controllable by the control device. It is possible for the at least one storage unit to be a water electrolysis unit, an accumulator or a compressed air storage unit. Positive or negative load reserves can be formed by energy stores.

According to a development the method also includes collecting information based on process data, the information being sent by a generator of the electrical energy in the separate autonomous network and by the two or more sub-plants; and controlling the provision of electrical energy within the separate autonomous network on the basis of the information. This enables intelligent control with load management to be realized. Intelligent control can e.g. also incorporate “initiation and supervision of synchronization”.

EP 2015011 A1 (SIEMENS AKTIENGESELLSCHAFT), Jul. 12, 2007, describes a load control algorithm for a gas liquefaction plant on the basis of intelligent control with load management. The algorithm can be applied analogously for the purpose of controlling electrical energy in the metallurgical plant.

According to a development, the method also includes providing electrical energy by at least one power generating plant having two or more turbines; calculating the requisite number and the capacity utilization of the turbines so that the energy required for operation of the two or more sub-plants is provided, taking into account a load reserve.

According to a development, one of the sub-plants is a steelworks having at least one electric arc furnace, wherein controlling the provision of power includes providing electrical power for the at least one electric arc furnace at the expense of at least one other of the two or more sub-plants.

According to a development the method includes interrupting the electricity supply to at least one of the other sub-plants or supplying at least one of the other sub-plants with a limited amount of electrical power during the operation of the at least one electric arc furnace.

According to a development, the method additionally includes, if the steelworks has two or more electric arc furnaces, operating the electric arc furnaces in separate time periods from one another.

According to a development, the method additionally includes charging, e.g., continuously, the at least one electric arc furnace with hot direct-reduced iron (=HDRI) provided by a direct reduction plant of the metallurgical plant. This eliminates the need for energy-intensive reheating of the iron and several process steps, thereby lowering the energy requirements. As a result of energy-saving metallurgical methods, such as the use of HDRI and/or continuous charging or operation of the EAFs, the energy requirements and/or the load dynamics are reduced, which is very advantageous for a separate autonomous network.

### BRIEF DESCRIPTION OF THE DRAWINGS

These and other aspects and advantages will become more apparent and more readily appreciated from the following description of the exemplary embodiments taken in conjunction with the accompanying drawings, in which:

FIG. 1 is a schematic block diagram providing a representation of a metallurgical plant;

FIG. 2 is a block diagram of an automation scheme for a metallurgical plant;

FIG. 3 is a block diagram of an energy network monitoring and control system (ENMC) of a metallurgical plant; and

FIG. 4 is a flowchart of a load computer algorithm of the control device for the deactivation of preselected turbines.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

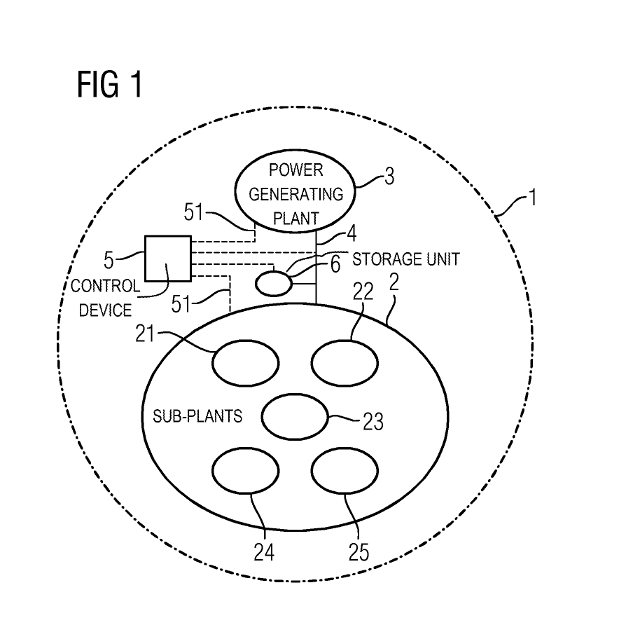

FIG. 1 shows a schematic view of a metallurgical plant 1. As electricity-consuming loads 2, the plant 1 has five metallurgical sub-plants 21 to 25, specifically an ore extraction plant 21, an iron making plant 22, an electric steel plant 23 having an EAF, a conveyor plant 24 and infrastructure ancillary plants 25. The ore extraction plant 21 includes a mine, an ore processing plant and auxiliary plants. The iron making plant 22 includes a pellet plant, an HDRI plant and auxiliary plants. The electric steel plant 23 includes a meltshop, a casting plant, a rolling mill and auxiliary plants, e.g. for supplying oxygen and water. The conveyor plant 24 include three conveying systems. The infrastructure ancillary plants 25 includes accommodations, a laundry, a canteen and a drinking water supply.

In addition, the metallurgical plant 1 includes a power generating plant 3 having a gas turbine for generating electrical energy in the electricity network 4, and an electricity network 4 for distributing electrical energy. The electricity network 4 connects the power generating plant 3 to the electricity-consuming loads 2.

The electricity network 4 together with the electricity-consuming loads 2 connected thereto and the power generating plant 3 forms a separate autonomous network, i.e. an electricity network in which the metallurgical sub-plants 21, 22, 23 obtain 100% of the electrical energy required for their operation from the power generating plant 3.

The metallurgical plant 1 further includes a control device 5 which is able to control the power generating plant 3, the electricity distribution network 4 and the electricity-consuming loads 2 by way of control lines 51.

The metallurgical plant 1 also includes a storage unit 6 for buffering electrical energy. A temporary storage of electrical energy in the storage unit 6 can be controlled by the control device 5 by a control line 51.

As a result of the integration of the metallurgical sub-plants 21, 22 and 23, which can be operated independently of one another, into the metallurgical plant, the state-of-the-art energy generation by a gas turbine and the intelligent control of the energy distribution by the control device 5, which controls a provision of electrical power for the steelworks 23 at the expense of the ore extraction plant 21, the iron making plant 22, the conveyor plant 24 and the infrastructure ancillary plants 25, it is possible to supply the electric steel plant 23 with electrical energy in isolated standalone operation.

When the EAF is powered up, secondary electricity-consuming loads are either deactivated completely or switched over into an operating state having lower energy consumption. When the EAF is powered down, the secondary electricity-consuming loads are once again operated in the operating state that they were in prior to the activation of the EAF, or are even switched over into an operating state having higher energy consumption.

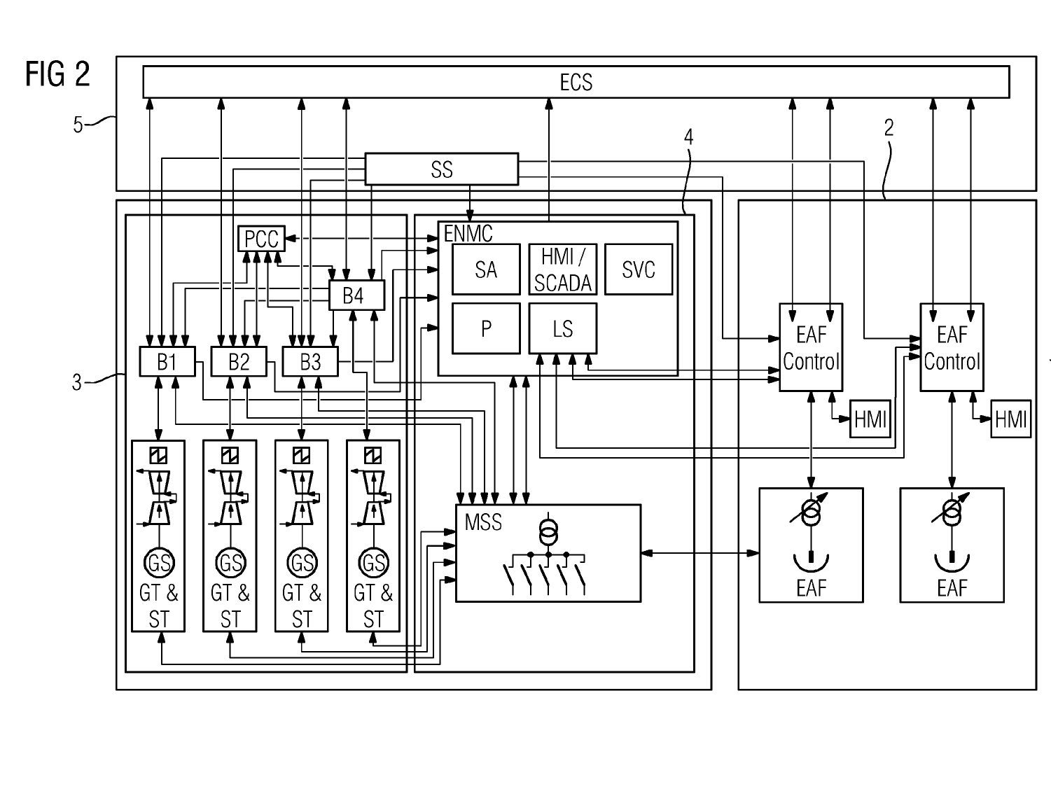

FIG. 2 shows a typical automation scheme for a metallurgical plant having four power generating plant blocks.

The groups of generators 3, distributors 4 and loads 2 embodied as automation islands are interconnected in a network by way of high-speed data links. The control device 5, e.g. in the form of a load computer, receives information calculated from the process data continuously from the generator side 3 and the load side 2 in order, in the event of the unscheduled downtime of a generator and/or outage/shutdown of one or more large-scale loads, e.g. one or more EAFs, to be able to react with corrective countermeasures so rapidly that neither the stability limits of the electricity network 4, in particular in relation to frequency and voltage, are exceeded, nor do the electric EAFs deviate into unstable load states. Corresponding decision algorithms are stored in the control device 5 for this purpose.

The power generator 3 has a plurality of blocks B1 to B4, each having one GS plant Gas Turbine and Steam Turbine (GT&ST). The term GS plant or GS block designates a plant unit for joint use of at least one gas turbine and at least one steam turbine in which the waste heat from typically two gas turbines is made use of in a waste heat recovery boiler in order to generate steam for a steam turbine. Individual generator and turbine controllers (“TCS”=Turbine Control System) are connected to one another and to a higher-ranking power generating plant controller PPC (=Power Plant Control) by bidirectional signal exchange lines.

Each of the blocks B1 to B4 engages in bidirectional signal exchange with the power generating plant controller PPC, which for its part engages in bidirectional signal exchange with an energy network monitoring and control system ENMC of the electricity distribution network 4.

Four power generating plant blocks B1 to B4 are shown in the present example, although it goes without saying that the power generator 3 can include an arbitrary number N of power generating plant blocks, where N is a natural number.

The energy network monitoring and control system ENMC includes a high-voltage substation automation unit SA, a protection unit P, a human machine interface/supervisory control and data acquisition unit HMI/SCADA, a load shedding unit LS, and a static VAr compensation unit SVC (VAr=Volt-Ampere reactive).

Each of the blocks B1 to B4 likewise engages in bidirectional signal exchange with a main load distribution station MSS (=Main Sub-Station), which has switches and transformers. In parallel therewith, the main load distribution station MSS engages in bidirectional signal exchange with the energy network monitoring and control system ENMC. Each of the turbines GT&ST of a GS block also engages in bidirectional signal exchange with the main load distribution station MSS.

The electricity-consuming loads 2 include two arc furnaces EAF, to each of which is assigned a dedicated EAF control unit EAF Control. A bidirectional signal exchange takes place between the arc furnaces EAF and the EAF control units EAF Control. Each of the EAF control units EAF Control is assigned a human-machine interface HMI, a bidirectional signal exchange taking place between the EAF control units EAF Control and the human-machine interface HMI. The EAF control units EAF Control and the energy network monitoring and control system ENMC engage in bidirectional signal exchange.

The control device 5 includes an electricity control system ECS (=Electrical Control System) and further load distribution sub-stations SS (=Sub-Stations) of the metallurgical plant. Unidirectional signal lines go from the load distribution sub-stations SS to the blocks B1 to B4, the energy network monitoring and control system ENMC and the EAF control units EAF Control. The electricity control system ECS engages in bidirectional signal exchange with the blocks B1 to B4 and the EAF control units EAF Control. One unidirectional signal line goes from the energy network monitoring and control system ENMC to the electricity control system ECS.

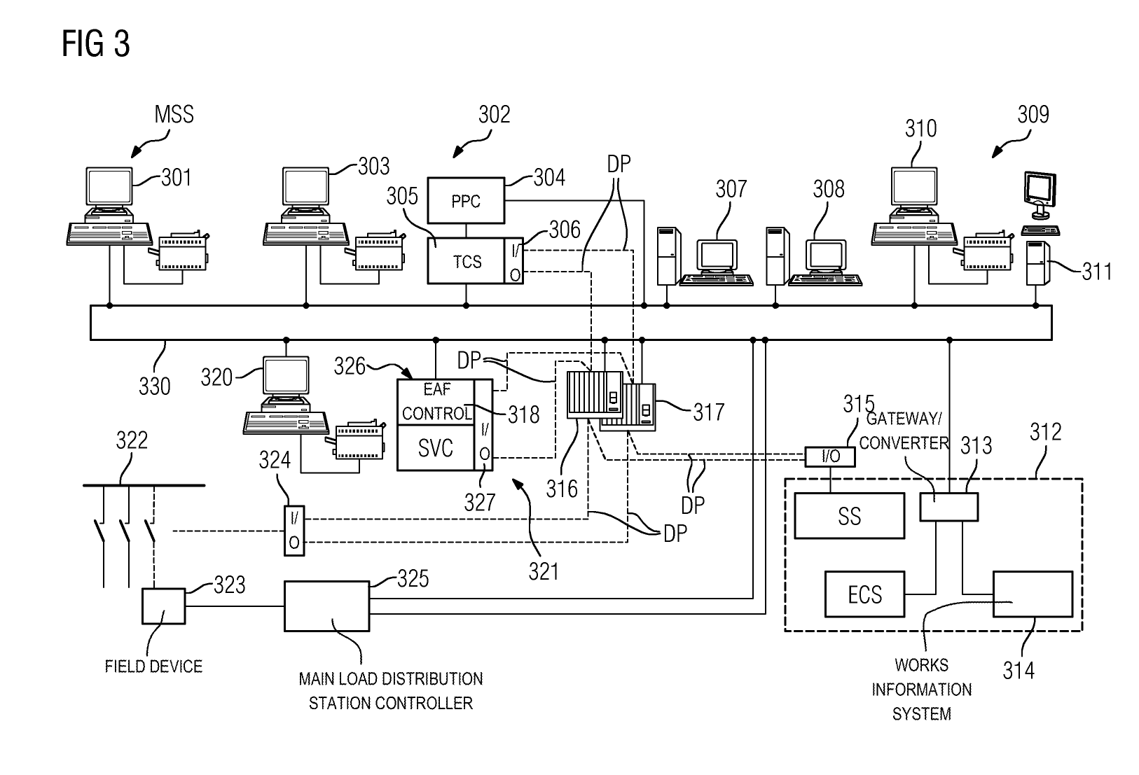

FIG. 3 shows an energy network monitoring and control system (=ENMC system) of a metallurgical plant according to a further exemplary embodiment. A data loop line 330, e.g. an Ethernet loop, connects different units of the metallurgical plant.

A main load distribution station MSS includes a master control station 301 and a main load distribution station controller 325, each of which is connected to the data loop line 330. A field device 323 which controls a main busbar 322 is connected to the main load distribution station controller 325 by way of a further data line.

A power generating plant metrology room 302 includes a master control station 303, a higher-ranking power generating plant controller 304 (=PPC), power generating plant unit controllers 305 (=TCS), and SCADA/HMI servers 307 and 308, which are each connected to the data loop line 330. The power generating plant controller 304 and the power generating plant unit controllers 305 are not included in the scope of the power regime of the ENMC system.

A central control room 309 includes a master control station 310 and an engineering station 311, each of which is connected to the data loop line 330.

A further unit 312, which is not included in the scope of the power regime of the ENMC system, includes a gateway/converter 313 which is connected to the data loop line 330. An electricity control system ECS of the metallurgical plant and a works information system 314 are connected to the gateway/converter 313.

The ENMC system additionally includes two load shedding controllers 316 and 317 which are connected to the data loop line 330. The load shedding controllers 316 and 317 may include, e.g., SIMATIC® S7-400 PLCs.

The steelworks includes a master control station 320 and a steelworks control unit 326 having EAF controllers 318 and a static VAr compensation unit SVC, the master control station 320 and the steelworks control unit 326 each being connected to the data loop line 330.

The load shedding controllers 316 and 317 are connected to the power generating plant unit controllers 305, the further unit 312, the main busbar 322 and the steelworks control unit 326 by way of redundant serial bus lines DP and a remote I/O bus station 306, 315, 324, 327 in each case. A suitable device for use as a remote I/O bus station 306, 315, 324, 327 is e.g. the SIMATIC® ET 200M, while e.g. PROFIBUS DP can be used with a fiber optic cable as serial bus lines DP.

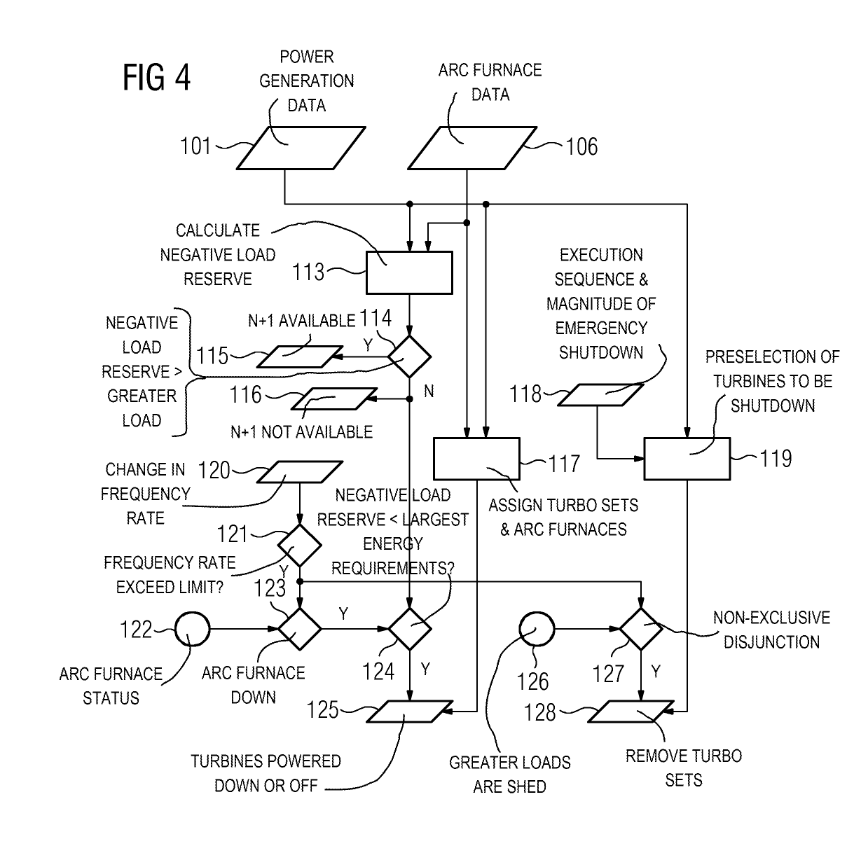

FIG. 4 shows a decision algorithm that is applicable to an unscheduled shutdown of large-scale electricity-consuming loads such as arc furnaces. This algorithm is stored in the control device 5. The power generating plant and machine control and communication system is configured so as to be able to correctively compensate for load throw-offs of this order of magnitude without the assistance of a dynamic load computer.

In order to assess the load conditions, the dynamic load computer continuously receives information 101 from the power generating plant control and communication system in relation to all GS plants GT&ST, e.g. the current power, the positive reserve, the negative reserve, and the availability of a turbine. In addition, the dynamic load computer constantly receives information 106 from the steelworks in relation to all arc furnaces, e.g. the current load and the reserve.

If the total negative load reserve achievable by frequency regulation is greater than the greatest amount of load shedding that is to be assumed by shutting down arc furnaces, the dynamic load computer does not intervene. Otherwise a preselected turbo set (=GS plant) is operated at reduced power or powered down, and the resulting positive load reserve compensates for the remaining gap. In this case reference numeral 113 denotes the calculation of the negative load reserve and the identification of the arc furnaces having the greatest load. These two values are compared in 114. If the negative load reserve is greater than the greater load of the arc furnaces, the computer reports “n+1 available” 115. In the alternative case it reports “n+1 not available” 116.

An assignment 117 of turbo sets and arc furnaces is carried out on the basis of the data from the power generating plant control and communication system 101 and the data of the arc furnaces 106. Preselected turbines are operated at reduced power or powered down 125 with the aid of the assignment if the negative load reserve is less than 124 the energy requirements of the largest arc furnaces and either an arc furnace 122 goes down 123 or the change in frequency rate 120 in the energy supply network of the metallurgical plant exceeds 121 a predetermined limit.

If even greater loads are shed 126, e.g. in the event of partial emergency shutdowns from the process, it may be necessary to remove a plurality of suitable turbo sets from the network 128 by tripping, i.e. by initiating a fastest possible removal of the driving energy for turbine emergency shutdown. If the execution sequence and magnitude 118 of such an emergency shutdown are known, such an operation can also be controlled in principle by the load computer, e.g. in that a preselection 119 of turbines that are to be shut down is made in order where necessary to enable a sub-process to continue in operation. Large shedding of loads 126 and the exceeding 121 of a limit of the change in frequency rate 120 are linked to one another in the manner of a non-exclusive disjunction 127.

Although the method has been illustrated and described in greater detail on the basis of exemplary embodiments, the method is not limited by the disclosed examples and other variations can be derived herefrom by the person skilled in the art without leaving the scope of protection of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-13. (canceled)

14. A method for supplying a metallurgical plant, having at least two metallurgical sub-plants, with electrical energy in isolated standalone operation by way of a separate autonomous network, the electrical energy being provided in the separate autonomous network by at least one power generating plant, comprising:
delivering at least 80 percent of electrical power required for operation of the metallurgical sub-plants from the separate autonomous network, where the at least one power generating plant includes at least one gas turbine;
delivering additional electrical power required for the operation of the metallurgical sub-plants by way of a connection of the separate autonomous network to an external electrical power supply network; and
controlling provision of sub-plant electrical power by supplying the electrical power required for a first sub-plant and not supplying the electrical power required for at least one other of the at least two metallurgical sub-plants, the at least two metallurgical sub-plants including at least one steelworks having at least one electric arc furnace and at least one process sub-plant performing a metallurgical process arranged at least one of upstream and downstream of the at least one steelworks.

15. The method as claimed in claim 14, further comprising:
collecting information based on process data from a generator of the electrical energy in the separate autonomous network and the at least two metallurgical sub-plants; and
controlling the provision of electrical energy within the separate autonomous network based on the information collected.

16. The method as claimed in claim 15, further comprising:
providing electrical energy by the at least one power generating plant having at least two turbines; and
calculating a requisite number and capacity utilization of the at least two turbines to supply the electrical power required for operation of the at least two metallurgical sub-plants and have a load reserve.

17. The method as claimed in claim 14,
wherein one of the metallurgical sub-plants is a steelworks having at least one electric arc furnace, and
wherein said controlling the provision of power comprises providing the electrical power for the at least one electric arc furnace and not providing all of the electrical power required for at least one other of the at least two metallurgical sub-plants.

18. The method as claimed in claim 17, further comprising, during the operation of the at least one electric arc furnace, one of
interrupting the electrical power supplied to at least one of the other metallurgical sub-plants, and
supplying at least one of the other metallurgical sub-plants with a limited amount of electrical power.

19. The method as claimed in claim 18, further comprising, when the steelworks includes at least two electric arc furnaces, operating the at least two electric arc furnaces in separate time periods.

20. The method as claimed in claim 18, further comprising continuously charging the at least one electric arc furnace with hot direct-reduced iron provided by a direct reduction plant of the metallurgical plant.

21. The method as claimed in claim 17, further comprising, when the steelworks includes at least two electric arc furnaces, operating the at least two electric arc furnaces in separate time periods.

22. The method as claimed in claim 17, further comprising continuously charging the at least one electric arc furnace with hot direct-reduced iron provided by a direct reduction plant of the metallurgical plant.

23. The method as claimed in claim 15, wherein the at least one process sub-plant is at least one of an ore extraction plant, an ore processing plant, a pellet plant, an iron making plant, a direct reduction plant, a casting plant, a shaping plant, a finishing plant, a conveyor plant, and an auxiliary plant.

24. The method as claimed in claim 15, wherein the first sub-plant is a steelworks having at least one electric arc furnace.

25. The method as claimed in claim 15, wherein said controlling the provision of electrical power is performed by a control device connected by data lines exchanging process data with the at least one power generating plant and at least one of the at least two metallurgical sub-plants.

26. The method as claimed in claim 25, wherein the data lines are at least one of redundantly configured bus lines and optical data lines.

27. The method as claimed in claim 25, further comprising controlling, by the control device, temporary storage of the electrical energy in at least one storage unit, thereby buffering said providing of the electrical energy.

28. The method as claimed in claim 27, wherein the at least one storage unit is a water electrolysis unit.

29. The method as claimed in claim 15, wherein the at least one power generating plant has at least one gas turbine block and at least one steam turbine block.

30. The method as claimed in claim 14, wherein the electrical power delivered by said delivering is 90 percent of the electrical power required for the operation of the metallurgical sub-plants.

31. The method as claimed in claim 14, further comprising:
providing electrical energy by the at least one power generating plant having at least two turbines; and
calculating a requisite number and capacity utilization of the at least two turbines to supply the electrical power required for operation of the at least two metallurgical sub-plants and have a load reserve.

32. The method as claimed in claim 14, wherein the at least one process sub-plant is at least one of an ore extraction plant, an ore processing plant, a pellet plant, an iron making plant, a direct reduction plant, a casting plant, a shaping plant, a finishing plant, a conveyor plant, and an auxiliary plant.

33. The method as claimed in claim 14, wherein the first sub-plant is a steelworks having at least one electric arc furnace.

34. The method as claimed in claim 14, wherein said controlling the provision of electrical power is performed by a control device connected by data lines exchanging process data with the at least one power generating plant and at least one of the at least two metallurgical sub-plants.

35. The method as claimed in claim 14, wherein the at least one power generating plant has at least one gas turbine block and at least one steam turbine block.
